(19) United States
(12) Patent Application Publication
(10) Pub. No.: US 2012/0031881 A1
(43) Pub. Date: Feb. 9, 2012

(54) Blow-Back Plasma Arc Torch With Shield Fluid-Cooled Electrode

(75) Inventor: David C. Griffin, Florence, SC (US)

(73) Assignee: The ESAB Group, Inc.

(21) Appl. No.: 12/852,772

(22) Filed: Aug. 9, 2010

(51) Int. Cl. B23K 9/00

(52) U.S. Cl. 219/121.5

(57) ABSTRACT

A blow-back plasma arc torch employs a plasma gas and a separately supplied secondary fluid. The secondary fluid serves to internally cool an electrode of the torch and to shield the plasma gas and arc emanating from the primary nozzle of the torch. The secondary fluid can be a gas or liquid water. Secondary fluid or plasma gas is used to actuate a piston to which the electrode is connected so as to move the electrode from a starting position to an operating position. The secondary fluid is supplied to the torch at a greater mass flow rate than the plasma gas.

### BACKGROUND OF THE INVENTION

The present disclosure relates generally to plasma arc torches, and more particularly to plasma arc torches of the retract or blow-back type in which the electrode is retracted during starting by means of fluid pressure acting on a piston connected to the electrode.

### BRIEF SUMMARY OF THE DISCLOSURE

The present disclosure describes a plasma arc torch of the retract or blow-back type, in which separate supplies of plasma gas and secondary fluid are provided to the torch, and the torch's electrode is cooled by the secondary fluid. The secondary fluid can be a gas or liquid water, and is also used as a shield fluid for shielding the stream of plasma gas and the electric arc that issue from the primary nozzle of the torch.

In one embodiment, the plasma arc torch described herein comprises:
a torch body assembly defining a cylindrical bore therein, at least one plasma gas supply passage for conducting a flow of a plasma gas, and at least one secondary fluid supply passage for conducting a flow of a secondary fluid that is supplied to the torch separately from the plasma gas;
an electrode assembly including an electrode at a lower end of the electrode assembly, the electrode assembly defining internal passages for receiving secondary fluid and circulating the secondary fluid within the electrode assembly for cooling the electrode;
a primary nozzle coupled to the torch body assembly adjacent the electrode and defining a plasma nozzle chamber therebetween and defining a primary orifice through which plasma gas in the plasma nozzle chamber is discharged and through which an arc from the electrode extends during a transferred-arc mode of operation of the torch;
a piston connected to the electrode and comprising a piston rod joined to a piston head assembly, the piston head assembly sealingly engaging an inner surface of the cylindrical bore in the torch body assembly such that the piston is axially slidable in the cylindrical bore;
an actuating chamber defined between a lower surface of the piston head assembly and the cylindrical bore, the torch being configured to supply one of the plasma gas and the secondary fluid into the actuating chamber, wherein sufficient pressure in the actuating chamber urges the piston upwardly from a starting position in which the electrode is in contact with the primary nozzle to an operating position in which the electrode is spaced from the primary nozzle; and
a secondary nozzle coupled to the torch body assembly and defining a secondary nozzle chamber that receives secondary fluid that has cooled the electrode, and defining one or more secondary orifices through which secondary fluid in the secondary nozzle chamber is discharged so as to generally surround the plasma gas and arc;
whereby the secondary fluid cools the electrode and shields the plasma gas and arc.

The torch can be configured in various ways. For example, the torch can include passages that direct secondary fluid into the actuating chamber, either before or after the secondary fluid cools the electrode, in order to move the piston and electrode, after which the secondary fluid is discharged from the secondary nozzle to shield the plasma gas and arc. Alternatively, the torch can include passages that direct plasma gas into the actuating chamber for moving the piston and electrode, after which the plasma gas is discharged from the primary nozzle, and the torch can include passages for directing secondary fluid into the electrode, after which the secondary fluid is discharged from the secondary nozzle to shield the plasma gas and arc.

In all of the various embodiments, the secondary fluid that cools the electrode is supplied at a greater mass flow rate than the plasma gas. This allows the electrode to be cooled without dependence on the flow rate requirement of the plasma gas. In contrast, with conventional blow-back torches that employ a single gas that is split into plasma and shield gas streams within the torch, electrode cooling is necessarily dependent on (subservient to) the flow rate requirement for the plasma gas stream, because once the plasma gas stream's flow rate is determined, that also fixes the total flow rate, and hence the flow rate of gas available for cooling the electrode.

In some embodiments, the torch can be configured for employing a gas as the secondary fluid. In other embodiments, the torch can be configured for employing water as the secondary fluid. When water is the secondary fluid, none of the water supplied to the torch is recirculated.

When the secondary fluid is a gas (e.g., air), the torch can include one or more vent holes arranged to vent some of the secondary fluid to atmosphere. In this manner, a portion of the secondary fluid supplied to the torch shields the plasma gas and arc and the remainder of the secondary fluid supplied to the torch is vented through the vent hole(s). This can allow a greater flow rate of secondary fluid for cooling the electrode, beyond the flow rate needed for shielding of the plasma gas and arc.

In one embodiment, the piston is moved by secondary fluid supplied to the actuating chamber, and the secondary fluid first cools the electrode before entering the actuating chamber. The electrode assembly comprises a tubular electrode holder having an upper end connected to the piston and a lower end connected to the electrode. The electrode holder contains an internal coolant tube having an upper end arranged to receive secondary fluid from an internal cavity in the piston and a lower end arranged to discharge the secondary fluid against an inner surface of the electrode to cool the electrode. A coolant return passage is defined between the coolant tube and the electrode holder for conducting the secondary fluid away from the electrode after cooling of the electrode, and the electrode holder defines one or more holes connecting the coolant return passage to the actuating chamber.

Various passage configurations can be used for providing secondary fluid to the electrode and to the actuating chamber. For example, the piston head assembly and cylindrical bore can define a transfer chamber that is isolated from the actuating chamber, and secondary fluid can be supplied into the transfer chamber, from which the secondary fluid passes into the internal cavity in the piston for supply to the electrode. The piston head assembly can comprise a first piston head and a second piston head axially spaced below the first piston head such that the transfer chamber is defined by the axial space between the first and second piston heads. An O-ring or other seal can be arranged between each piston head and the inner surface of the bore for sealing purposes.

In one embodiment, the torch is configured to conduct the secondary fluid first into the transfer chamber, then into the electrode assembly to cool the electrode, then into the actuating chamber, then into the secondary nozzle chamber, and finally out the one or more secondary orifices.

Alternatively, a transfer chamber need not be included, and secondary fluid can be supplied to the electrode in other ways. For example, secondary fluid can be supplied through a central passage in the piston (e.g., by a hose connected to the end of the piston) to the electrode.

A compression spring can be arranged to constantly bias the piston toward the starting position. Sufficient pressure in the actuating chamber overcomes the spring so as to move the piston to the operating position.

The torch in some embodiments can be associated with a valve that shuts off supply of plasma gas to the torch when the valve is closed and allows plasma gas to be supplied to the torch when the valve is open. The valve is structured and arranged to be opened by pressure of the secondary fluid being supplied to the torch and to be closed when the secondary fluid is not being supplied to the torch. This can allow the torch to be used with power supplies having a single gas outlet.

A method for operating the plasma arc torch is also disclosed herein. One method comprises the steps of:
beginning with the torch in a starting condition in which the piston is in the starting position having the electrode in contact with the primary nozzle;
supplying a plasma gas to the at least one plasma gas supply passage of the torch;
supplying, separately from the supply of the plasma gas, a secondary fluid to the at least one secondary fluid supply passage of the torch;
the piston being moved to the operating position by pressure in the actuating chamber such that the electrode is moved out of contact with the primary nozzle, while establishing a voltage potential difference between the electrode and the primary nozzle such that an arc extends between the electrode and the primary nozzle; and
transitioning to an operating condition of the torch in which the arc attaches to a workpiece.

The method can also include the step of venting to atmosphere a fraction of the secondary fluid being supplied to the torch so that said fraction does not pass through the one or more secondary orifices.

The plasma gas can be one of air, nitrogen, oxygen, argon, and H35, and the secondary fluid can be one of air, nitrogen, and liquid water.

In one embodiment, the secondary fluid is supplied to the secondary fluid supply passage at a mass flow rate that exceeds that required for achieving a desired flow rate of secondary fluid out the one or more secondary orifices, wherein excess secondary fluid above the desired flow rate is vented to atmosphere, and wherein the mass flow rate of the secondary fluid is determined at least in part based on a requirement for cooling of the electrode.

In some embodiments a gas is supplied as the secondary fluid, and a flow rate of the secondary fluid is greater than a flow rate of the plasma gas in the operating condition of the torch.

In some embodiments the torch can be operatively associated with a valve that shuts off supply of plasma gas to the torch when the valve is closed and allows plasma gas to be supplied to the torch when the valve is open. The valve is structured and arranged to be opened by pressure of the secondary fluid being supplied to the torch and to be closed when the secondary fluid is not being supplied to the torch. The method includes the step of supplying the secondary fluid so as to open the valve and allow the plasma gas to flow to the torch.

### BRIEF DESCRIPTION OF THE SEVERAL VIEWS OF THE DRAWING(S)

Having thus described the disclosure in general terms, reference will now be made to the accompanying drawings, which are not necessarily drawn to scale, and wherein:

FIG. 1 is an axial cross-sectional view, on a first plane, through a plasma arc torch in accordance with one embodiment described herein;

FIG. 2 is an axial cross-sectional view, on a second plane, through the plasma arc torch of FIG. 1; and

FIG. 3 is a diagrammatic depiction of a torch in accordance with another embodiment described herein.

### DETAILED DESCRIPTION OF THE DRAWINGS

The present invention now will be described more fully hereinafter with reference to the accompanying drawings in which some but not all embodiments of the inventions are shown. Indeed, these inventions may be embodied in many different forms and should not be construed as limited to the embodiments set forth herein; rather, these embodiments are provided so that this disclosure will satisfy applicable legal requirements. Like numbers refer to like elements throughout.

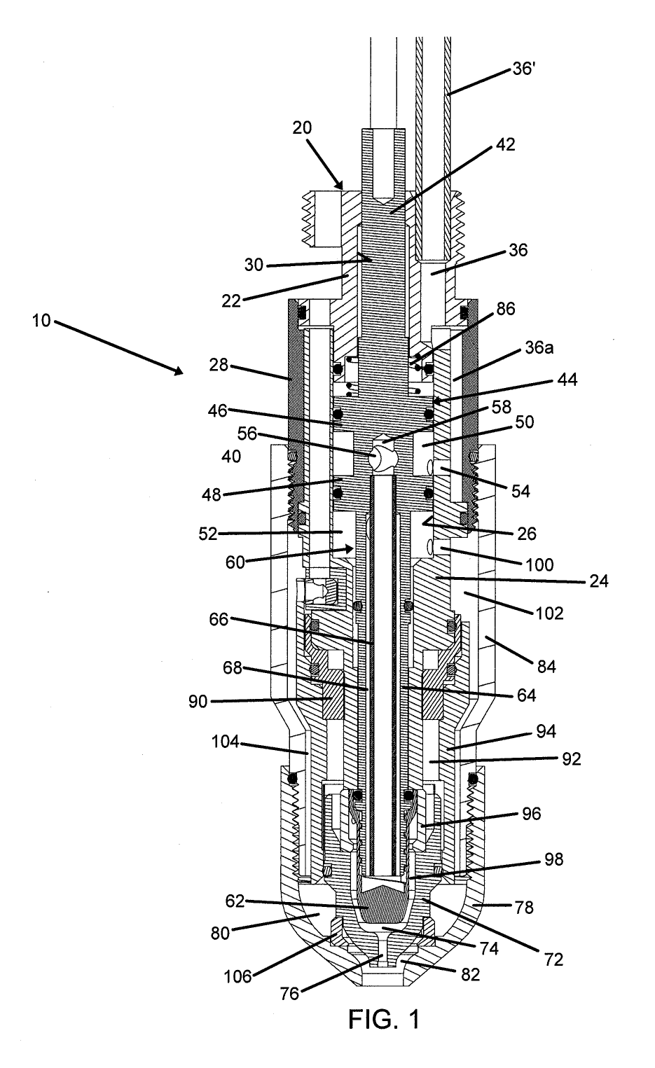

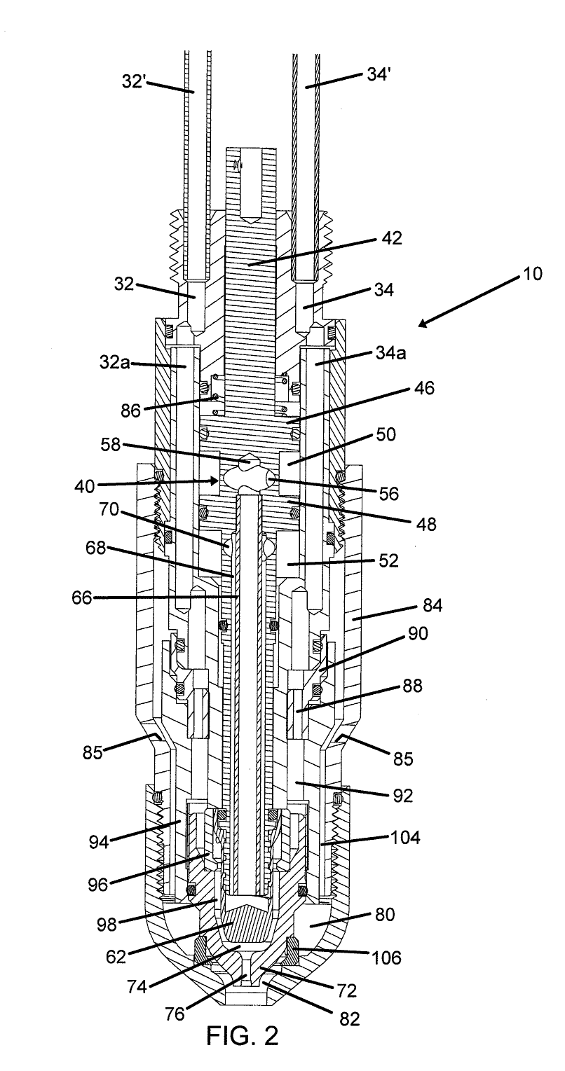

A plasma arc torch 10 in accordance with one embodiment of the present invention is illustrated in FIGS. 1 and 2, which show cross-sections of the torch on two different planes that pass through a central longitudinal axis of the torch and are angularly displaced from each other about the longitudinal axis. Thus, some features such as fluid flow paths or other features that are located at discrete locations about the longitudinal axis may be visible on one cross-section but not the other, or may appear differently on the two cross-sections.

The plasma arc torch 10 includes a torch body assembly 20 that comprises an upper body member 22 and a lower body member 24. The lower body member 24 defines a cylindrical bore 26 extending axially therethrough. The cylindrical bore 26 is substantially coaxial with the longitudinal axis of the torch. The lower body member 24 is surrounded by a body insulator 28. The upper body member 22 includes a lower portion that is received in the cylindrical bore 26 with an O-ring disposed between an outer surface of the upper body member 22 and the inner surface of the cylindrical bore 26 so as to seal the interface therebetween. An upper portion of the upper body member 22 is received in the central opening of the body insulator 28 with an O-ring disposed between the outer surface of the upper body member 22 and the inner surface of the body insulator 28 so as to seal the interface therebetween. The upper body member 22 also defines a central bore 30 extending therethrough, aligned with the cylindrical bore 26 in the lower body member 24.

The torch body assembly 20 also defines at least one plasma gas supply passage for conducting a flow of a plasma gas, and at least one secondary fluid supply passage for conducting a flow of a secondary fluid that is supplied to the torch separately from the plasma gas. More particularly, in the illustrated embodiment the upper body member 22 includes a first plasma gas supply inlet 32 and a second plasma gas supply inlet 34 that respectively receive two plasma gas supply conduits 32′ and 34′. The upper body member 22 further includes a secondary fluid supply inlet 36 that receives a secondary fluid supply conduit 36′.

The first and second plasma gas supply inlets 32 and 34 are respectively aligned with first and second plasma gas supply passages 32a and 34a defined in the lower body member 24. The secondary fluid supply inlet 36 is aligned with a secondary fluid supply passage 36a defined between the lower body member 24 and the body insulator 28.

The torch further includes a piston 40 comprising a piston rod 42 joined to a piston head assembly 44. The piston head assembly 44 sealingly engages the inner surface of the cylindrical bore 26 in the torch body assembly such that the piston 40 is axially slidable in the cylindrical bore 26. A recessed region of the piston head assembly 44 and the inner surface of the cylindrical bore 26 define a transfer chamber 50 therebetween. In the illustrated embodiment, the recessed region is provided by way of the piston head assembly having a first piston head 46 and a second piston head 48 that are axially spaced apart, such that the recessed region is the axial space between the two piston heads. The piston head assembly 44 (specifically, the second piston head 48) isolates the transfer chamber 50 from an actuating chamber 52 defined between a lower surface of the piston head assembly 44 and the cylindrical bore 26.

The lower body member 24 defines a secondary fluid flow path 54 connecting the secondary fluid supply passage 36a to the transfer chamber 50 for supplying secondary fluid to the transfer chamber 50.

The piston 40 defines one or more passages 56 arranged to receive secondary fluid from the transfer chamber 50 and conduct the secondary fluid into an internal cavity 58 in the piston 40.

An electrode assembly 60 is connected to the piston 40 and includes an electrode 62 at a lower end of the electrode assembly 60. The electrode assembly 60 defines internal passages for receiving secondary fluid from the internal cavity 58 of the piston 40 and circulating the secondary fluid within the electrode assembly 60 for cooling the electrode 62 and then conducting the secondary fluid into the actuating chamber 52. More particularly, in the illustrated embodiment, the electrode assembly 60 comprises a tubular electrode holder 64 having an upper end connected to the piston 40 and a lower end connected to the electrode 62. The electrode holder 64 contains an internal coolant tube 66 having an upper end arranged to receive secondary fluid from the internal cavity 58 in the piston 40 and a lower end arranged to discharge the secondary fluid against an inner surface of the electrode 62 to cool the electrode. A coolant return passage 68 is defined between the outer surface of the coolant tube 66 and the inner surface of the tubular electrode holder 64 for conducting the secondary fluid away from the electrode 62 after cooling of the electrode. The electrode holder 64 defines one or more holes 70 connecting the coolant return passage 68 to the actuating chamber 52.

The plasma arc torch 10 further includes a primary nozzle 72 coupled to the torch body assembly 20 (specifically, coupled to the lower body member 24) adjacent the electrode 62 and defining a plasma nozzle chamber 74 therebetween. The primary nozzle 72 defines a primary orifice 76 through which plasma gas in the plasma nozzle chamber 74 is discharged and through which an arc from the electrode 62 extends during a transferred-arc mode of operation of the torch 10. A secondary nozzle 78 (sometimes also referred to as a shield nozzle) is coupled to the torch body assembly 20 and defines a secondary nozzle chamber 80 and one or more secondary orifices 82 through which secondary fluid in the secondary nozzle chamber 80 is discharged so as to generally surround the plasma gas and arc emanating from the primary orifice 76. Specifically, in the illustrated embodiment the secondary nozzle 78 is threaded onto a lower end of a shield retainer 84 whose upper end is threaded onto the body insulator 28, which in turn is coupled to the upper and lower body members 22 and 24 as previously described. The illustrated embodiment has a secondary nozzle 78 that defines a single annular secondary orifice 82 between the secondary nozzle and the primary nozzle. Alternatively, the secondary nozzle could define a series of discrete secondary orifices if that were desirable in a particular application.

When there is sufficient pressure of the secondary fluid in the actuating chamber 52, the piston 40 is urged upwardly from a starting position (not shown) in which the electrode 62 is in contact with the primary nozzle 72 to an operating position (shown in FIGS. 1 and 2) in which the electrode 62 is spaced from the primary nozzle 72. Upward movement of the piston 40 is resisted by a compression spring 86 arranged in the cylindrical bore 26 and having its upper end engaged against the upper body member 22 and its lower end engaged against the first piston head 46. Thus, the pressure in the actuating chamber 52 must overcome the sum of the spring force plus friction in order to move the piston 40 to the operating position.

Plasma gas supplied through the plasma gas supply inlets 32 and 34 proceeds through the plasma gas supply passages 32a and 34a defined in the lower body member 24, then through holes 88 in an insulator 90 that is coupled to a lower end of the lower body member 24, then through an annular passage 92 defined between a pilot arc body 94 and the insulator 90, and then through tangentially angled swirl holes (not readily visible) in a ceramic swirl ring 96 into an annular passage 98 defined between the primary nozzle 72 and the electrode 62. The swirl ring 96 imparts swirl to the plasma gas before it enters the plasma nozzle chamber 74, so that the plasma gas is swirling as it exits through the primary orifice 76.

With regard to the secondary fluid's progression through the torch after its passage into the actuating chamber 52, there is a secondary fluid passage 100 (specifically, a series of circumferentially spaced passages 100) defined in the lower body member 24 and connecting the actuating chamber 52 with the secondary nozzle chamber 80. More particularly, in the illustrated embodiment the secondary fluid proceeds through the secondary fluid passages 100 into an annular flow path 102 defined between the lower body member 24 and the shield retainer 84, then through an annular passage 104 defined between the shield retainer 84 and the pilot arc body 94, and finally into the secondary nozzle chamber 80. A secondary swirl ring 106 is disposed between the secondary nozzle 78 and the primary nozzle 72 downstream of the secondary nozzle chamber 80. The secondary swirl ring includes tangentially angled swirl holes (not readily visible) that impart swirl to the secondary fluid flowing from the secondary nozzle chamber 80 so that the secondary fluid is discharged from the secondary orifice 82 as a swirling flow.

The torch 10 can also include provisions for venting some of the secondary fluid to atmosphere so that it does not pass through the secondary orifice 82. In the illustrated embodiment this is accomplished by providing one or more vent holes 85 in the shield retainer 84. Thus, a fraction of the total secondary fluid supplied through the secondary fluid supply inlet 36 will be vented to atmosphere through the vent hole(s) 85 and the remainder of the secondary fluid will pass through the secondary orifice 82 for shielding the plasma arc. The main benefit of venting some of the secondary fluid is that an excess amount of secondary fluid can be supplied to the torch, beyond what is needed for the desired amount of shielding of the plasma arc, so that greater cooling of the electrode can be accomplished. Venting would be used only when the secondary fluid is a gas (and particularly when it is air) as opposed to liquid water. When operating at high arc currents and using air as the secondary fluid, a high flow rate of secondary fluid is needed in order to achieve adequate electrode cooling. Venting some of the air allows attainment of the needed flow rate for cooling, yet preserves the desired amount of shielding. Operation at lower arc currents generally would not require venting, in which case a shield retainer not have vent holes could be employed.

Operation of the torch 10 is now described. Beginning with the torch in a starting condition in which the piston 40 is in the starting position having the electrode 62 in contact with the primary nozzle 72, operation proceeds by supplying a plasma gas through the plasma gas supply conduits 32′ and 34′ into the plasma gas supply inlets 32 and 34 of the torch. At roughly the same time, separately from the supply of the plasma gas, a secondary fluid is supplied through the secondary fluid supply conduit 36′ into the secondary fluid supply passage 36 of the torch. These gas/fluid supplies are regulated by suitable flow regulators (not shown) as understood in the art. The secondary fluid is supplied at a flow rate and pressure sufficient to move the piston 40 to the operating position such that the electrode 62 is moved out of contact with the primary nozzle 72, while at the same time a voltage potential difference is established between the electrode 62 and the primary nozzle 72 (the electrode 62 being the cathode and the primary nozzle 72 being the anode) such that a pilot arc extends between the electrode and the primary nozzle. Once the pilot arc is established, this pilot arc is “blown out” the primary orifice 76 and attaches to the workpiece. The current is ramped up and the torch is transitioned to an operating condition wherein instead of the primary nozzle 72 being the anode, the workpiece (not shown) is the anode. The desired operation on the workpiece can then proceed.

The torch 10 can be used with any of various plasma gases and secondary fluids. The particular plasma gas and secondary fluid employed will generally depend on the specific operation being performed, the type of metal being operated on, and other factors that would be understood by persons skilled in the art. As non-limiting examples, the plasma gas can be selected from air, nitrogen, oxygen, argon, and H35 (a mixture of argon and hydrogen), and the secondary fluid can be selected from air, nitrogen, and liquid water.

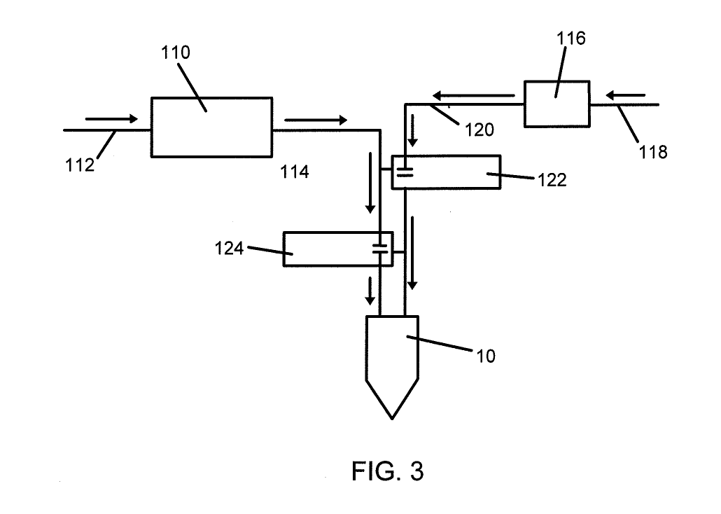

Some users of plasma arc torches of the conventional blow-back type (in which there is a single gas supplied to the torch, the gas in some torches being split into plasma/actuating gas and shield gas streams within the torch) possess power supplies that have only a single-gas capability. Such power supplies are adequate for use with the conventional single-gas type torches, but would not be able to supply both plasma gas and secondary fluid to the torch 10 described herein. However, such single-gas power supplies can be used with the present torch when the torch system is modified as shown in FIG. 3. The system includes a plasma arc torch 10 generally as described above, and a single-gas power supply 110 that includes a suitable gas flow regulator (not shown) along with components (also not shown) for regulating the electrical power supplied to the torch. Secondary fluid is supplied via a supply line 112 to an inlet of the power supply 110 and is discharged from the power supply as a regulated stream through a supply line 114 (which generally corresponds to, or feeds, the secondary fluid supply conduit 36′ described above). The system includes a separate regulator 116 for regulating the flow of plasma gas. Plasma gas enters the regulator 116 via a supply line 118 and exits as a regulated stream through a supply line 120 (which generally corresponds to, or feeds, the plasma gas supply conduits 32′ and 34′ described above).

The system includes a fluid-actuated valve 122 interposed in the plasma gas supply line 120 that shuts off supply of plasma gas to the torch when the valve is closed and allows plasma gas to be supplied to the torch when the valve is open. The valve 122 is structured and arranged to be opened by pressure of the secondary fluid being supplied to the torch and to be closed when the secondary fluid is not being supplied to the torch. Thus, secondary fluid carried in the supply line 114 is tapped off and supplied to the valve 122 to serve in opening the valve 122 whenever the secondary fluid is being supplied at a sufficient pressure to open the valve. In this manner, plasma gas will be supplied to the torch only when secondary fluid is being supplied to the torch by the power supply 110.

The system can also include a gas-actuated valve 124 interposed in the secondary fluid supply line 114 downstream of the fluid-actuated valve 122. The gas-actuated valve 124 functions similarly to the valve 122 but is opened by pressure of the plasma gas carried in the plasma gas supply line 120. The inclusion of the gas-actuated valve 124 has the advantage that secondary fluid is supplied to the torch only if plasma gas is also being supplied to the torch. If the valve 124 were omitted, and if for some reason only the secondary fluid were being supplied, the “parts-in-place” system that is built into many plasma arc torch systems (which ensures that pilot arc current is supplied only when secondary fluid is present and the consumables are properly installed in the torch) would not “know” that plasma gas is not present. Inclusion of the valve 124 solves this problem by preventing secondary fluid from being supplied to the torch if plasma gas is not also being supplied.

The system depicted in FIG. 3 can also be used with other types of plasma arc torches that employ both plasma gas and a separate secondary fluid. It is not limited for use with blow- back torches such as described herein.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. For example, as previously noted, while the illustrated torch 10 employs the secondary fluid as the fluid for actuating the piston 40, alternatively a torch in accordance with the invention can employ the plasma gas for actuating the piston. Additionally, while the illustrated torch is configured to cool the electrode with the secondary fluid before the secondary fluid enters the actuating chamber, alternatively the secondary fluid could pass through the actuating chamber before entering the electrode to cool it. Although specific terms are employed herein, they are used in a generic and descriptive sense only and not for purposes of limitation.

What is claimed is:

1. A plasma arc torch, comprising:
a torch body assembly defining a cylindrical bore therein, at least one plasma gas supply passage for conducting a flow of a plasma gas, and at least one secondary fluid supply passage for conducting a flow of a secondary fluid that is supplied to the torch separately from the plasma gas;
an electrode assembly including an electrode at a lower end of the electrode assembly, the electrode assembly defining internal passages for receiving secondary fluid and circulating the secondary fluid within the electrode assembly for cooling the electrode;
a primary nozzle coupled to the torch body assembly adjacent the electrode and defining a plasma nozzle chamber therebetween and defining a primary orifice through which plasma gas in the plasma nozzle chamber is discharged and through which an arc from the electrode extends during a transferred-arc mode of operation of the torch;
a piston connected to the electrode and comprising a piston rod joined to a piston head assembly, the piston head assembly sealingly engaging an inner surface of the cylindrical bore in the torch body assembly such that the piston is axially slidable in the cylindrical bore;
an actuating chamber defined between a lower surface of the piston head assembly and the cylindrical bore, the torch being configured to supply one of the plasma gas and the secondary fluid into the actuating chamber, wherein sufficient pressure in the actuating chamber urges the piston upwardly from a starting position in which the electrode is in contact with the primary nozzle to an operating position in which the electrode is spaced from the primary nozzle; and
a secondary nozzle coupled to the torch body assembly and defining a secondary nozzle chamber that receives secondary fluid that has cooled the electrode, and defining one or more secondary orifices through which secondary fluid in the secondary nozzle chamber is discharged so as to generally surround the plasma gas and arc;
whereby the secondary fluid cools the electrode and shields the plasma gas and arc.

2. The plasma arc torch of claim 1, wherein the torch is configured to supply secondary fluid into the actuating chamber for moving the piston.

3. The plasma arc torch of claim 2, wherein the torch is configured such that secondary fluid passes through the internal passages in the electrode assembly before flowing through the actuating chamber.

4. The plasma arc torch of claim 3, wherein the piston includes an internal cavity into which secondary fluid is supplied from the at least one secondary fluid supply passage, wherein the electrode assembly comprises a tubular electrode holder having an upper end connected to the piston and a lower end connected to the electrode, the electrode holder containing an internal coolant tube having an upper end arranged to receive secondary fluid from the internal cavity in the piston and a lower end arranged to discharge the secondary fluid against an inner surface of the electrode to cool the electrode, a coolant return passage being defined between the coolant tube and the electrode holder for conducting the secondary fluid away from the electrode after cooling of the electrode, and the electrode holder defining one or more holes connecting the coolant return passage to the actuating chamber.

5. The plasma arc of claim 4, wherein the piston head assembly includes a recessed region and a transfer chamber is defined between the recessed region and the inner surface of the cylindrical bore, the piston head assembly isolating the transfer chamber from the actuating chamber, and further comprising:
a secondary fluid flow path connecting the at least one secondary fluid supply passage to the transfer chamber for supplying secondary fluid to the transfer chamber;
the piston defining one or more passages arranged to receive secondary fluid from the transfer chamber and conduct the secondary fluid into the internal cavity in the piston.

6. The plasma arc torch of claim 5, wherein the piston head assembly comprises a first piston head and a second piston head axially spaced below the first piston head such that the recessed region of the piston head assembly comprises an axial space between the first and second piston heads.

7. The plasma arc torch of claim 1, further comprising a compression spring arranged to constantly bias the piston toward the starting position, sufficient pressure in the actuating chamber overcoming the spring so as to move the piston to the operating position.

8. The plasma arc torch of claim 1, further comprising one or more vent holes arranged to vent some of the secondary fluid to atmosphere, whereby a portion of the secondary fluid supplied to the torch shields the plasma gas and arc and the remainder of the secondary fluid supplied to the torch is vented through the vent hole(s).

9. The plasma arc torch of claim 1, configured for employing a gas as the secondary fluid.

10. The plasma arc torch of claim 1, configured for employing water as the secondary fluid, and wherein none of the water supplied to the torch is recirculated.

11. The plasma arc torch of claim 1, further comprising a valve that shuts off supply of plasma gas to the torch when the valve is closed and allows plasma gas to be supplied to the torch when the valve is open, wherein the valve is structured and arranged to be opened by pressure of the secondary fluid being supplied to the torch and to be closed when the secondary fluid is not being supplied to the torch.

12. A method for operating the plasma arc torch of claim 1, comprising the steps of:
beginning with the torch in a starting condition in which the piston is in the starting position having the electrode in contact with the primary nozzle;
supplying a plasma gas to the at least one plasma gas supply passage of the torch;
supplying, separately from the supply of the plasma gas, a secondary fluid to the at least one secondary fluid supply passage of the torch;
the piston being moved to the operating position by pressure in the actuating chamber such that the electrode is moved out of contact with the primary nozzle, while establishing a voltage potential difference between the electrode and the primary nozzle such that an arc extends between the electrode and the primary nozzle; and
transitioning to an operating condition of the torch in which the arc attaches to a workpiece.

13. The method of claim 12, wherein a gas is supplied as the secondary fluid, and further comprising the step of venting to atmosphere a fraction of the secondary fluid being supplied to the torch so that said fraction does not pass through the one or more secondary orifices.

14. The method of claim 13, wherein the secondary fluid is supplied to the secondary fluid supply passage at a mass flow rate that exceeds that required for achieving a desired flow rate of secondary fluid out the one or more secondary orifices, wherein excess secondary fluid above said desired flow rate is vented to atmosphere, and wherein the mass flow rate of the secondary fluid is determined at least in part based on a requirement for cooling of the electrode.

15. The method of claim 12, wherein a flow rate of the secondary fluid is greater than a flow rate of the plasma gas in the operating condition of the torch.

16. The method of claim 12, wherein the plasma gas is one of air, nitrogen, oxygen, argon, and H35, and the secondary fluid is one of air, nitrogen, and liquid water.

17. The method of claim 12, wherein the torch is operatively associated with a valve that shuts off supply of plasma gas to the torch when the valve is closed and allows plasma gas to be supplied to the torch when the valve is open, wherein the valve is structured and arranged to be opened by pressure of the secondary fluid being supplied to the torch and to be closed when the secondary fluid is not being supplied to the torch, and wherein the method further comprises the step of supplying the secondary fluid so as to open the valve and allow the plasma gas to flow to the torch.

18. A plasma arc torch system, comprising:
a plasma arc torch having an electrode, a primary nozzle defining a primary orifice, a secondary nozzle defining a secondary orifice, plasma gas passages for supplying a plasma gas to the primary nozzle, and separate secondary fluid passages for separately supplying a secondary fluid to the secondary nozzle;
a single-gas power supply operable for regulating supply of electrical power to the plasma arc torch and for regulating supply of the secondary fluid to the plasma arc torch;
a plasma gas regulator separate from the single-gas power supply and operable for regulating supply of the plasma gas to the plasma arc torch; and
a fluid-actuated valve disposed between the plasma gas regulator and the plasma arc torch, the fluid-actuated valve shutting off supply of plasma gas to the torch when the fluid-actuated valve is closed and allowing plasma gas to be supplied to the torch when the fluid-actuated valve is open, wherein the fluid-actuated valve is structured and arranged to be opened by pressure of the secondary fluid being supplied to the torch and to be closed when the secondary fluid is not being supplied to the torch.

19. The plasma arc torch system of claim 18, further comprising a plasma gas-actuated valve disposed between the fluid-actuated valve and the plasma arc torch, the plasma gas-actuated valve shutting off supply of secondary fluid to the torch when the plasma gas-actuated valve is closed and allowing secondary fluid to be supplied to the torch when the plasma gas-actuated valve is open, wherein the plasma gas-actuated valve is structured and arranged to be opened by pressure of the plasma gas being supplied to the torch and to be closed when the plasma gas is not being supplied to the torch.
